(19) United States
(12) Patent Application Publication
(10) Pub. No.: US 2008/0220278 A1
(43) Pub. Date: Sep. 11, 2008

(54) High rate electrochemical device

(76) Inventor: Robert Brian Dopp, Marietta, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/716,375

(22) Filed: Mar. 9, 2007

(51) Int. Cl. H01M 4/00

(52) U.S. Cl. 428/550; 429/128

(57) ABSTRACT

A device and system useful for highly efficient chemical and electrochemical reactions is described. The device comprises a porous electrode and a plurality of suspended nanoparticles diffused within the void volume of the electrode when used within an electrolyte. The device is suitable within a system having a first and second chamber preferably positioned vertically with respect to each other, and each chamber containing an electrode and electrolyte with suspended nanoparticles therein. When reactive metal particles are diffused into the electrode structure and suspended in electrolyte by gasses, a fluidized bed is established. The reaction efficiency is increased and products can be produced at a higher rate. When an electrolysis device can be operated such that incoming reactants and outgoing products enter and exit from opposite faces of an electrode, reaction rate and efficiency are improved. Ideally, this device and system can be used to rapidly produce significant quantities of high purity hydrogen gas with minimal electricity cost.

### BACKGROUND OF THE INVENTION

1. Technical Field

The inventions disclosed herein generally relate to a water electrolysis device for the production of high purity hydrogen and oxygen, and catalysts for this device which promote increased electrical and cost efficiency.

2. Related Art

Hydrogen is a renewable fuel that produces zero emissions when used in a fuel cell. In 2005, the Department of Energy (DoE) developed a new hydrogen cost goal and methodology, namely to achieve $2.00-3.00/gasoline gallon equivalent (gge, delivered, untaxed, by 2015), independent of the pathway used to produce and deliver hydrogen. The principal method to produce hydrogen is by stream reformation. Nearly 95% of the hydrogen currently being produced is made by steam reformation, where natural gas is reacted on metallic catalyst at high temperature and pressure. While this process has the lowest cost, four pounds of the greenhouse gasses carbon monoxide (CO) and carbon dioxide (CO.sub.2) are produced for every one pound of hydrogen. Without further costly purification to remove CO and CO.sub.2, the hydrogen fuel cell cannot operate efficiently.

Alternatively, 5% of hydrogen production is from water electrolysis. This reaction is the direct splitting of water molecules to produce hydrogen and oxygen. Note that greenhouse gasses are not produced in these reactions. In this process, electrodes composed of catalyst particles are submersed in water and energy is applied to them. Using this energy, the electrodes split water molecules into hydrogen and oxygen. Hydrogen is produced at the cathode electrode which accepts electrons and oxygen is produced at the anode electrode which liberates electrons. The amount of hydrogen and oxygen produced by an electrode is dictated by the current supplied to the electrodes. The efficiency depends upon the voltage between the two electrodes, and is proportional to the reciprocal of that voltage. That is to say; efficiency increases as the voltage decreases. A more catalytic system will have a lower voltage for any one current, and therefore be more efficient in producing hydrogen and oxygen. If the catalyst is highly efficient, there will be minimal energy input to achieve a maximum hydrogen output. Unfortunately, this process is currently too expensive to compete with steam reformation due low efficiency and the use of expensive catalysts in the electrodes.

Devices that are configured to electrochemically convert reactants into products when energy is applied are generally known as electrolyzers. For an electrolyzer to operate with high efficiency, the amount of product produced during reaction should be maximized relative to the amount of energy input. In many conventional devices, low catalyst utilization in the electrodes, cell resistance, inefficient movement of electrolyte, and inefficient collection of reaction products from the electrolyte stream contribute to significant efficiency loss. In many cases, low efficiency is compensated for by operating the cell at a low rate (current). This strategy does increase efficiency, however, it also lowers the amount of products that can be produced at a given time. The electrolyzer described in the preferred embodiments can operate both at high rates and efficiencies.

Fluidized bed reactors (FBRs) have been designed to carry out chemical reactions that take place between materials of the same or different phases (solids, liquids and/or gasses). In an FBR that contains catalyst particles, a gas or liquid is passed upwardly through the FBR with enough flow rate to cause suspension of the catalyst particles. While FBRs have been used in the chemical industry because of their positive heat and mass transfer characteristics, use of FBRs remain unexplored in conjunction with electrochemical cells.

### SUMMARY OF THE INVENTION

In one aspect of the invention, a high-surface area electrode is conceived. In one embodiment, the electrode comprises a porous or reticulate metal plate combined with catalytic metal particles, preferably at the nanoscale. The plate preferably includes some void volume to allow infusion of the nanosized metal particles. When immersed within an electrolyte, the metal particles can float freely and can substantially infuse into the porous/reticulate metal plate to create an electrode with extremely high surface area. This electrode can be applied to a variety of devices, including a hydrogen generation electrode in a water electrolyzer system. Essentially, in such an embodiment, the electrode functions as a fluidized bed. At least one advantage is that the electrode can be operated at very high current (rate), which in turn means that large amounts of hydrogen can be produced. Typical electrodes have a far lower surface area and thus cannot operate at rates significant enough to produce large quantities of hydrogen. Other advantages may include, depending upon the configuration, circumstances, and environment, the ability to scale the electrode to a wide variety of sizes, a high rate of hydrogen production, and the ability to minimize agglomeration by using nanosized particles.

In another aspect of the invention, a new electrochemical device is contemplated, preferably a water electrolysis device. Unlike traditional electrolyzers, such as that shown in FIG. 1, one embodiment of the inventive electrochemical device system may be oriented horizontally rather than vertically. With such an arrangement, electrolyte may be moved through the lower chamber, with oxygen being generated on the lower electrode. A deflector is preferably placed in the electrolyte stream to ensure removal of all generated oxygen from the system. Oxygen may be scrubbed from the electrolyte before it is circulated back into the system. With at least one embodiment, water generated from the reaction can move through a separator membrane to the upper chamber. The upper chamber electrode produces hydrogen gas. Because hydrogen gas is less dense than the electrolyte, the hydrogen may bubble upwards and can then be removed from the system. Preferably, a fluidized bed is established in the upper chamber employing catalytic nanoparticles. Contemporaneously, hydroxyl ions (OH—) are generated and may move downwardly through the separator for consumption at the lower chamber electrode. At least some advantages include, depending upon the configuration, circumstances, and environment, (i) that only half of the system may need pumping (unless the device is oriented on an angle, in which case no pumping may be necessary) whereas traditional systems need total pumping; (ii) half the pumping means half the parasitic losses; (iii) there is no need for a gas separator in the upper chamber; gas freely moves upward because it is less dense, and (iv) ions move from the bottom of the electrode while hydrogen escapes from the top, which gives a lower ionic resistance.

In yet another aspect of the invention, a fluidized bed electrolyzer may be provided that comprises a corrosion resistant container that houses a cylindrical separator. In one embodiment, porous anode and cathode electrodes may be disposed on the outer and/or inner circumference of the separator. The inner and outer chambers may be filled with electrolyte that preferably contains a plurality of reactive metal nanoparticles. Preferably, the generated anode and cathode gasses flow through the container in a manner that suspends the nanoparticles within the fluid, thus creating a fluidized bed. At least some advantages of this configuration include, (i) elimination of pumps via direct elimination of gasses from the upper vents and the self propagating nature of the fluidized bed, (ii) ease of keeping hydrogen and oxygen gasses separated, (iii) ease of controlling temperature and pressure, (iv) simple design, and (v) less expensive per unit of hydrogen produced, to name a few. Preferably, a number of vertical orientation electrolyzers are interconnected to function as an electrolyzer stack.

### BRIEF DESCRIPTION OF THE DRAWINGS

FIG. 1 is a schematic of a typical electrolysis device.

FIG. 2 is a schematic of one embodiment of an improved electrolysis device in which first and second chambers are oriented perpendicular with respect to each other.

FIG. 3A is a cross-sectional schematic view of one embodiment of an improved electrolysis device showing first and second chambers positioned concentrically in a vertical orientation.

FIG. 3B is an end schematic view of the embodiment of FIG. 3A.

FIG. 4 is an end schematic of one alternative embodiment of the device of FIG. 3A wherein there are multiple second chambers positioned within a large diameter first chamber.

FIG. 5 is a detailed view of metal particles in the upper chamber.

FIG. 6 plots the number of atoms on the surface of nanoparticles relative to particle diameter.

FIG. 7 is a chronovoltammetric plot showing the effect of metal particle addition.

FIG. 8 is a bar graph describing the change in voltage with the addition of different sized metal particles.

FIG. 9 is a polarization curve illustrating system performance at high current.

FIG. 10 is a bar graph illustrating comparing hydrogen generation on a fluidized bed versus other electrodes.

The features mentioned above in the summary of the invention, along with other features of the inventions disclosed herein, are described below with reference to the drawings of the preferred embodiments. The illustrated embodiments in the figures listed below are intended to illustrate, but not to limit the inventions.

### DETAILED DESCRIPTION OF SOME PREFERRED EMBODIMENTS

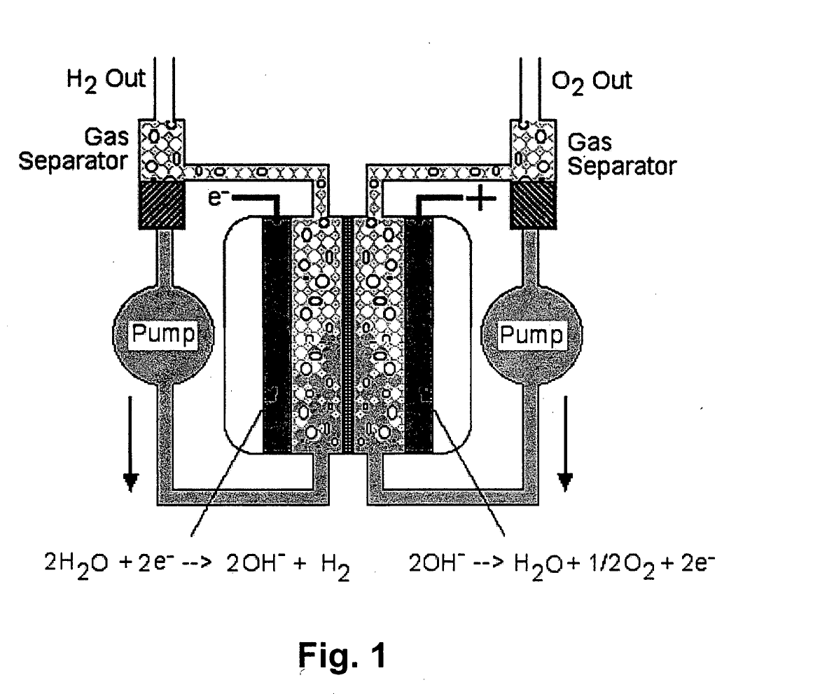

FIG. 1 illustrates a traditional electrolysis system. The main features of this system are pumps circulating at the anode and cathode to remove resulting oxygen and hydrogen gasses, respectively. The electrodes are typically oriented in a vertical fashion and are substantially solid. Oxygen and hydrogen gasses are scrubbed from the electrode before electrolyte returns to the cell. Electrodes are typically solid metal or electrodeposited metal with relatively low surface area.

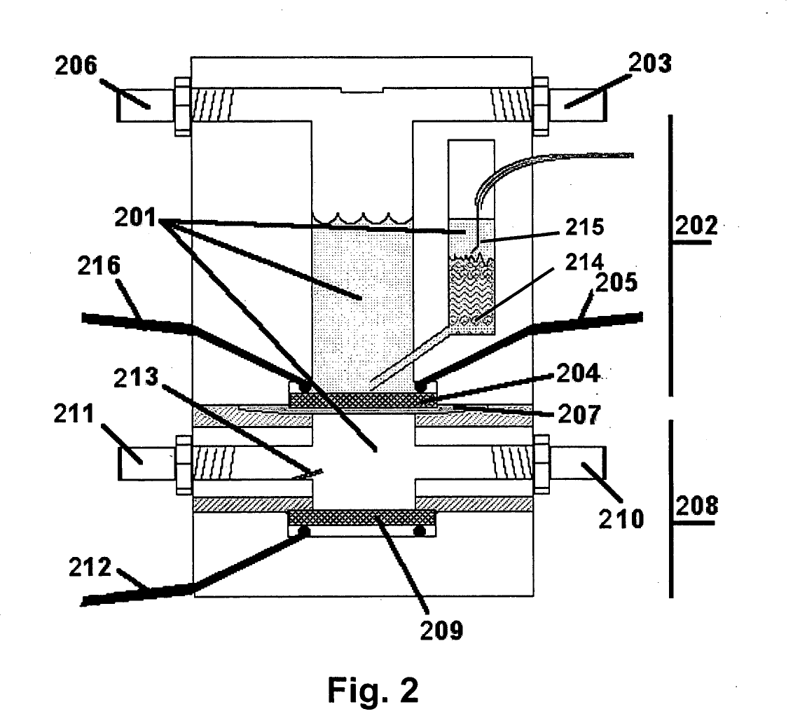

Referring to FIG. 2, one embodiment of an inventive electrolyzer configured to generate hydrogen and oxygen from water can be described. Electrolyte 201, such as aqueous potassium hydroxide (KOH) may be placed in a first chamber 202 via inlet port 203. When electricity is applied to cathode electrode 204 through electrical contact 205, hydrogen gas is produced by 2H₂O+2e⁻→H₂+2OH⁻. Because hydrogen gas is less dense than the electrolyte, it rises and leaves via port 206 to be collected or consumed. Hydroxyl ions produced in the reaction permeate downward through separator membrane 201. In a second chamber 208, electrolyte 201 is circulated parallel to anode electrode 209 via inlet port 211 and outlet port 210. In a preferred operative mode of at least one system embodiment, the system is oriented such that the first chamber 202 is positioned above the second chamber 208. Such an arrangement provides some advantages as discussed herein. It is contemplated, however, that another embodiment may comprise a system that is usefully oriented in such a manner that the first chamber is horizontally displaced relative to the second chamber, either in a side-by-side arrangement, or at some angle between vertical and horizontal.

When electricity is applied to electrode 209 via electrical contact 212, oxygen is produced pursuant to the following general reaction: 2OH—+H₂O+½O₂+2e⁻. Oxygen is eliminated from the electrolyte stream before the electrolyte is returned to the cell. To ensure that all oxygen is being eliminated from the upper surfaces of the lower chamber, angled deflector 213 is placed proximal to port 211 to ensure that deoxygenated electrolyte is washing the separator 207. For some system measurements, a side chamber containing separator mat 214 is filled with electrolyte 201, and reference electrode 215 is placed to measure electrochemical potential versus the upper chamber. Additionally, working reference electrode 216 is placed in contact with electrode 204.

The system configuration illustrated in FIG. 2 has several distinct advantages compared to the traditional electrolyzer shown in FIG. 1. In traditional electrolyzers, the entire volume of electrolyte fed into the system requires pumping and removal of hydrogen and oxygen gasses from the cathode and anode streams, respectively, resulting in parasitic losses. In the disclosed invention, the upper chamber acts on gravity and the electrolyte is stationary; hydrogen gas escapes from the top surface and inherently travels to the upper outlet port because it is less dense than both the electrolyte and air. Only the lower chamber requires electrolyte pumping to move oxygen out of the cell and flush new electrolyte into the system, thus this system has only half the parasitic loss of a traditional system.

The cathode electrode in the upper chamber has increased efficiency relative to a conventional electrode, in that reacting hydroxyl ions leave from the bottom of the electrode and resulting gas leaves from the top of the electrode. This minimizes ionic resistance in the device, as gas bubbles do not block catalyst sites on the electrode to outgoing hydroxyl ions or incoming water molecules.

In the lower chamber of the device, an angled deflector is placed proximal to the electrolyte inlet port. Because the electrolyte flows in a parallel fashion to the electrode surface and product gas rises, it is possible for gas bubbles to become lodged on the upper surface of the chamber proximal to the separator membrane, which can impede both water and ionic transport. By deflecting electrolyte to the upper surface of the chamber, the increased flow force of the electrolyte on that surface prevents gas bubbles from lodging and results in improved system efficiency.

In some of the preferred embodiments, the upper chamber features both an inlet and outlet port. One of the ports allows the removal of hydrogen gas from the system, and the other allows for direct injection of new electrolyte, compensatory water, or new catalyst. This feature allows for both simple cleaning and replenishment or replacement if catalyst and reactants.

Some of the preferred embodiments detail an increased available reaction surface through the use of porous electrodes. The electrodes can be prepared of networking metal particles, for example reticulate nickel or nickel foam. In other embodiments, the electrodes may be sintered metal plates, prepared such that the electrode is highly porous with a relatively large void volume. The electrodes are preferably prepared from metals, preferably selected from the group of metals from groups 3-16, and the lanthanide series. More preferably, the metals are transition metals, mixtures thereof, and alloys thereof and their respective oxides. Most preferably, the metal or metals are selected from the group consisting of nickel, iron, manganese, cobalt, tin, and silver, or combinations, alloys, and oxides thereof.

An aspect of at least some of the embodiments in this invention includes the realization that a reticulate or porous electrode's surface area can be increased significantly through the use of free moving reactive metal particles within the electrolyte. The electrolyte serves as both an ionic conductor and medium for the particles. Because of the reticulate or porous nature of the electrode, reactive metal particles can infuse into the electrode surface and become diffuse throughout the void volumes in the electrode. Preferably, the particles are less than one micron in effective diameter, and most preferably less than 100 nanometers in diameter. Most preferably, the reactive metal particles are less than 50 nm in diameter such that substantial portion can infuse into the electrode. Larger particles tend to agglomerate to the extent that the void volume within the electrode can no longer accommodate their size. This results in a significant loss in efficiency.

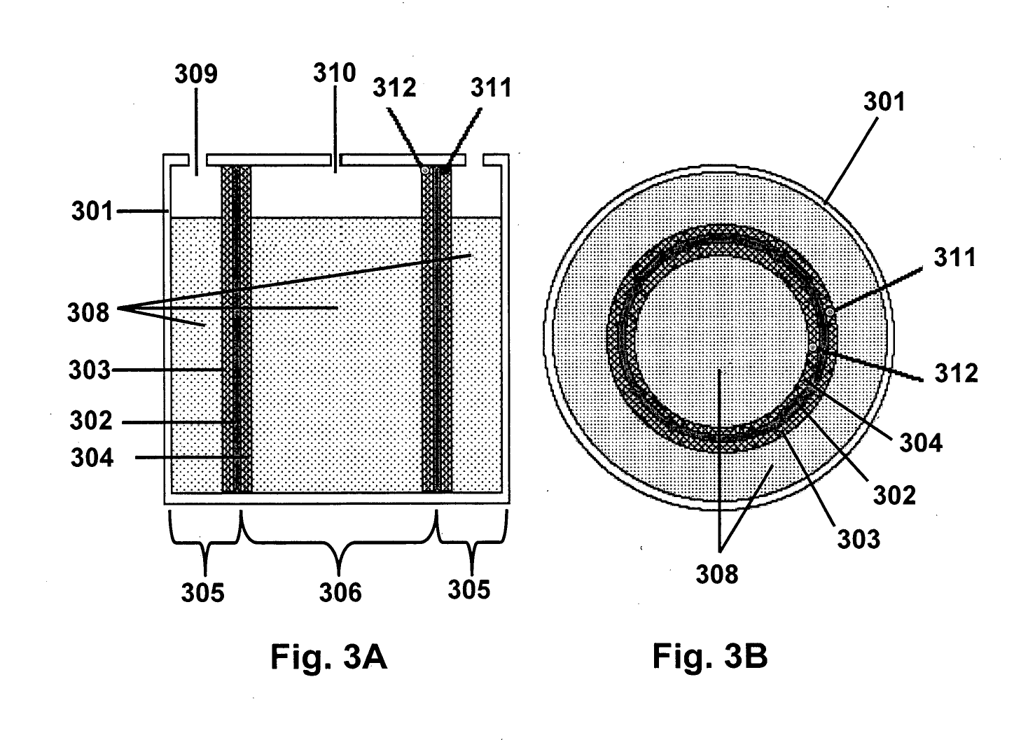

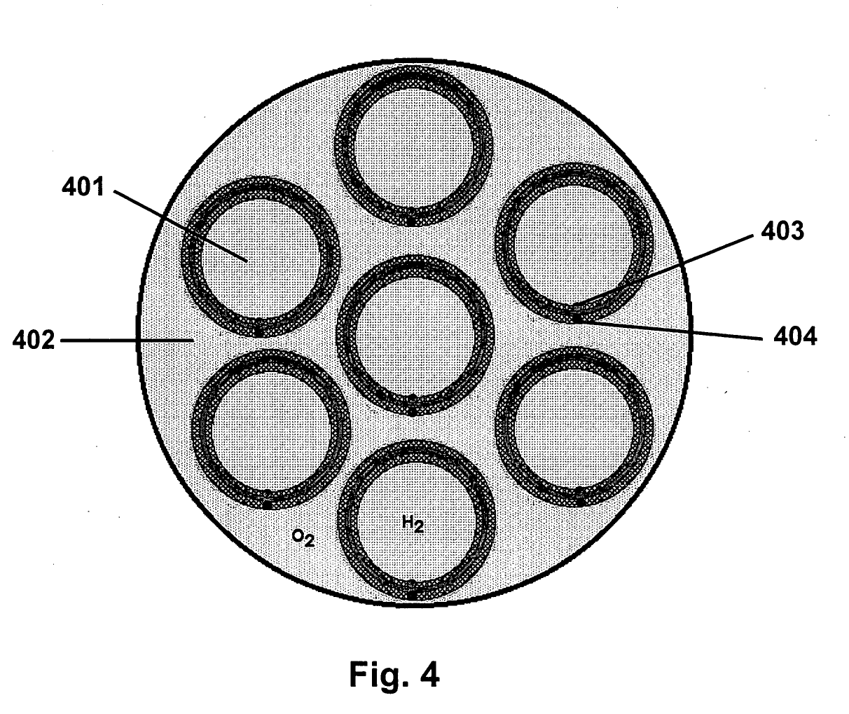

Referring to FIGS. 3A and 3B, another embodiment that comprises, in operation, a fluidized bed electrolysis reactor. The reactor comprises a corrosion resistant container 301 having one or several possible geometric configurations. The particular embodiment shown is generally cylindrical, with a generally cylindrical separator membrane 302 aligned, if so desired, concentrically with the container 301. The membrane 302 defines two chambers, an anode chamber and a cathode chamber. Porous or reticulate electrodes are disposed on each side of the membrane 302. Anode electrode 303 is disposed on the outer surface and cathode electrode 304 is disposed on the inner surface. Both the anode chamber 305 and cathode chamber 306 are filled with ionically conducting electrolyte 307, such as aqueous potassium hydroxide. Electrolyte 307 contains a plurality of reactive metal nanocatalysts particles 308 that are fluidized by the rising gasses in each chamber. Catalytic nanoparticles suspended in both the inner and outer chambers make contact with the electrodes through a percolation pathway. This percolation pathway is established when a plurality of the catalytic nanoparticles make contact with the porous or reticulate electrode as well as indirect contact through a chain of nanoparticles that ultimately make contact with the electrode. Electricity is applied to the electrodes via cathode electrical contact 311 and anode electrical contact 312 Oxygen is generated in the anode chamber. Because the density of oxygen is less than that of the electrolyte, it travels upward and leaves the system via port 309. Hydrogen is generated in the cathode chamber. Because hydrogen is less dense than the electrolyte, it travels upward and leaves the system via port 310. The movement of these resulting gas bubbles effectively fluidizes the reactive metal nanoparticles in the electrolyte such that the fluidized bed is self-propagating.

The system configuration illustrated in FIGS. 3A and 3B has several distinct advantages compared to the traditional electrolyzer shown in FIG. 1. In traditional electrolyzers, the entire volume of electrolyte fed into the system requires pumping and removal of hydrogen and oxygen gasses from the cathode and anode streams, respectively, resulting in parasitic losses. In the disclosed device, pumping is eliminated when a fluidized bed is established. Once fluidization occurs, considerably larger amounts of gas can be produced compared to a traditional electrolyzer. In addition, the device could be scaled to any conceivable size.

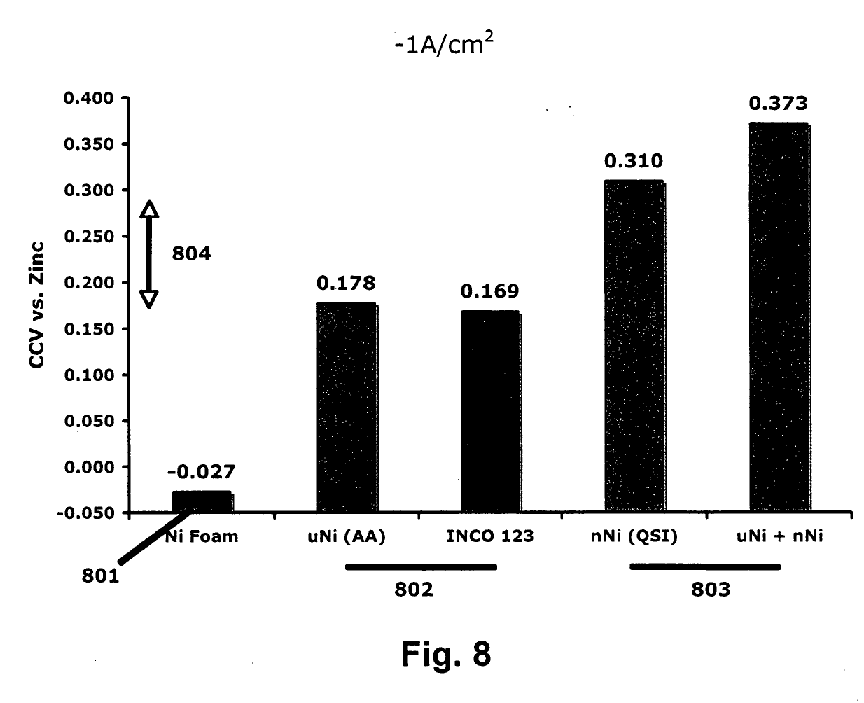

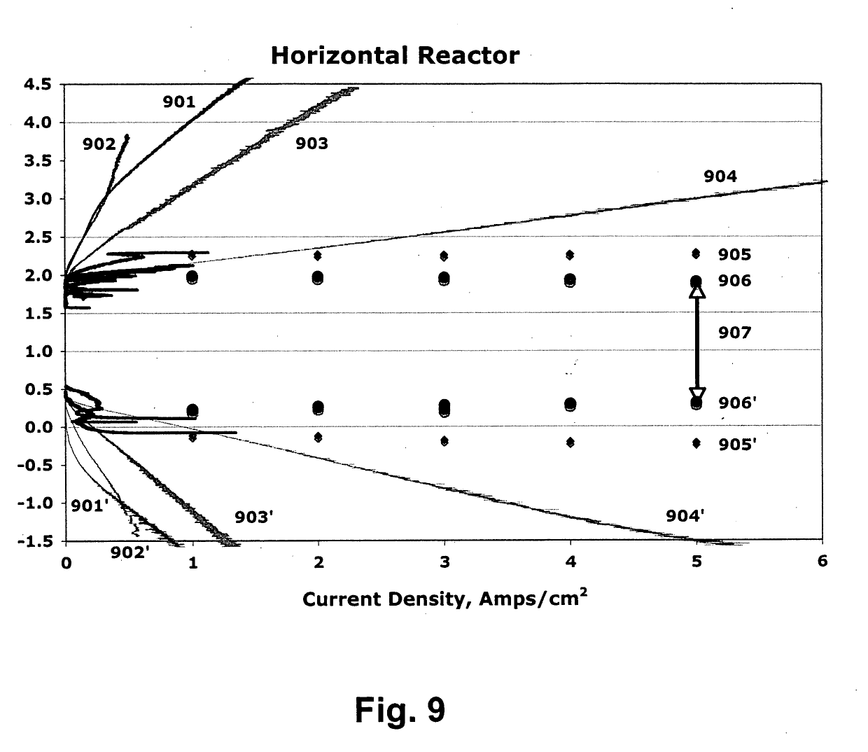

Referring to FIG. 9, multiple cells described in FIG. 8 can be connected for increased surface area and therefore increased hydrogen and oxygen production. Ions travel only a short distance through the separator, thus fluidized bed convection in both inner chambers 401 and outside chamber 402 the individual cells is not disturbed. Cathode electrode contacts 403 (negative terminals) would preferably be connected in parallel to the negative terminal of a power supply, and anode electrode contacts 404 (positive terminals) would be connected to the positive terminal of the power supply. Both the inside and outside volume of each cell contains a plurality of metal catalyst nanoparticles suspended in a fluidized bed when the device is operating. An additional advantage to operating multiple cells in this configuration is that because surface area is increased, internal resistance decreases and lowers parasitic losses. In this configuration seven cells are shown, however the configuration can be scaled with many more cells.

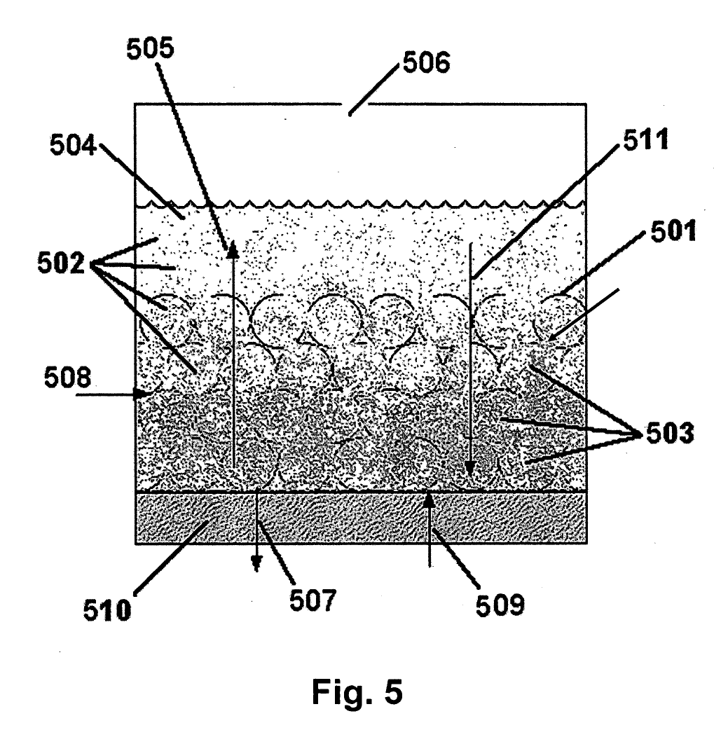

FIG. 5 illustrates an electrode infused with nanoparticles and with nanoparticles suspended in electrolyte. Electrode 501 is preferably a highly reticulate or porous, and can accommodate the infusion of nanoparticles 502 (shown as dots) that can diffuse throughout the void spaces within the interior of the electrode 503 and free moving in the electrolyte 504. When electricity 508 is applied to the electrode 501, water in the electrolyte that comes through separator 510 is split, producing hydrogen gas 505. The hydrogen gas 505 may diffuse upwardly and out of the top surface of the electrode 501, bubbling to the surface of the electrolyte to escape the apparatus 506. This bubbling maintains fluidization within the chamber. Meanwhile, hydroxyl ions 507 may move downwardly and permeate the separator membrane 510.

An electrode with infused nanoparticles has a larger reaction surface than the electrode alone. To illustrate the concept, a catalytic nanoparticle 502 touches the surface of electrode 501 and collects electrons 508, splitting two surrounding water molecules within the interior of the electrolyte 504 into an H₂ molecule 505 and two hydroxyl ions 507. The gas lifts the nanoparticle off the surface of the electrode 501, while a sister particle 511 replaces it to repeat the reaction. When the system is running at it's optimum, a fluidized bed is desirably established between the electrolyte, nano-catalysts and the tiny hydrogen gas bubbles. At least one aspect of the preferred embodiments includes the realization that gas or liquid does not necessarily need to be flowed into the bottom of the chamber once a fluidized bed has been established. In the described embodiments, gasses released from electrochemical reaction establish fluidization in-situ. A significant energy savings is inherent by eliminating the need for continuous pumping.

Unlike a traditional electrolyzer, whose efficiency decreases as current increases, a fluidized bed electrolyzer described in the preferred embodiments will increase in efficiency as current is increased, until a limiting current is reached in which further gas generation disrupts fluidization and the percolation pathway, ultimately lowering efficiency. Nevertheless, this limiting current at maximum efficiency is significantly higher in the devices described in the preferred embodiments compared to a traditional electrolysis system.

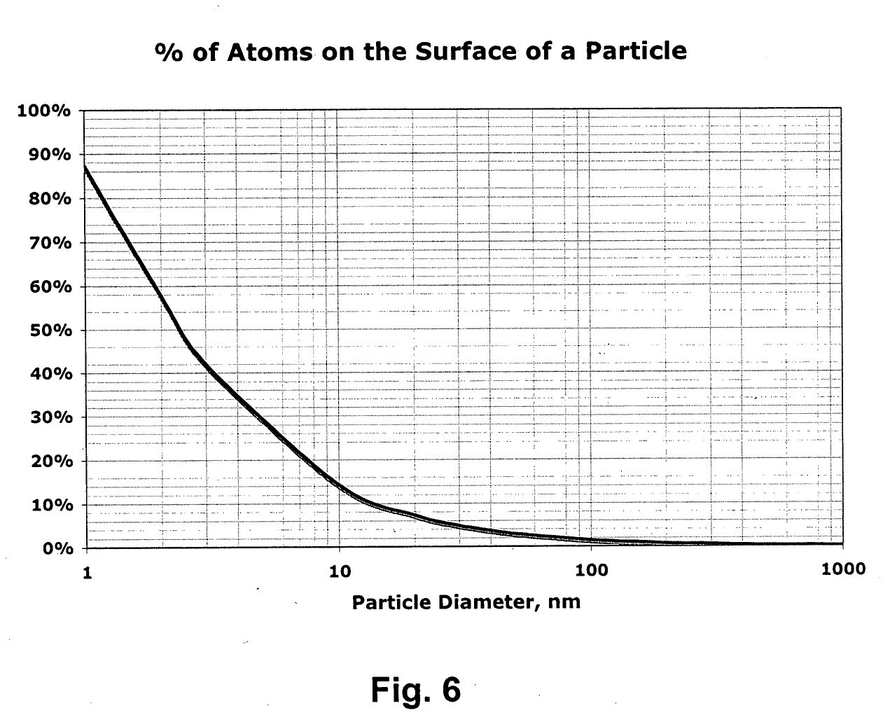

Additionally, reactive surface area is increased by order of magnitude by operation with catalytic nanoparticles in the fluidized bed. In addition to the surface area of the porous or reticulate electrode, and nanoparticles infused into the electrode, the system capitalizes on the additional surface area of the fluidized catalytic nanoparticles. The increased catalytic behavior of the reactive metal nanoparticles, compared to the surface of the metal substrate alone, is high due to the very large number of atoms on the surface of the nanoparticles, as shown in FIG. 6. By way of demonstration, consider a 3 nanometer nickel particle as a tiny sphere. Such a sphere would have 384 atoms on its surface and 530 within its interior, of the 914 atoms in total. This means that 58% of the nanoparticles would have the energy of the bulk material and 42% would have higher energy due to the absence of neighboring atoms. Nickel atoms in the bulk material have about 12 nearest neighbors while those on the surface have nine or fewer. A 3 micron sphere of nickel would have 455 million atoms on the surface of the sphere, 913 billion in the low energy and isolated interior of the sphere for a total of nearly one trillion atoms. That means that only 0.05% of the atoms are on the surface of the 3 micron-sized material compared to the 42% of the atoms at the surface of the 3-nanometer nickel particles.

The reactive metal particles can be formed through any known manufacturing technique, including, for example, but without limitation, ball milling, precipitation, plasma torch synthesis, combustion flame, exploding wires, spark erosion, ion collision, laser ablation, electron beam evaporation, and vaporization-quenching techniques such as joule heating.

Another possible technique includes feeding a material onto a heater element so as to vaporize the material in a well-controlled dynamic environment. Such technique desirably includes allowing the material vapor to flow upwardly from the heater element in a substantially laminar manner under free convection, injecting a flow of cooling gas upwardly from a position below the heater element, preferably parallel to and into contact with the upward flow of the vaporized material and at the same velocity as the vaporized material, allowing the cooling gas and vaporized material to rise and mix sufficiently long enough to allow nano-scale particles of the material to condense out of the vapor, and drawing the mixed flow of cooling gas and nano-scale particles with a vacuum into a storage chamber. Such a process is described more fully in U.S. patent Ser. No. 10/840,109, filed May 6, 2004, the entire contents of which is hereby expressly incorporated by reference.

The chemical kinetics of catalysts generally depend of the reaction of surface atoms. Having more surface atoms available will increase the rate of many chemical reactions such as combustion, electrochemical oxidation and reduction reactions, and adsorption. Extremely short electron diffusion paths, (for example, 6 atoms from the particle center to the edge in 3 nanometer particles) allow for fast transport of electrons through and into the particles for other processes. These properties give nanoparticles unique characteristics that are unlike those of corresponding conventional (micron and larger) materials. The high percentage of surface atoms enhances galvanic events such as the splitting of water molecules into its composite gasses of hydrogen and oxygen. FIG. 3 shows this relationship well.

The reactive metal particles referenced herein are preferably selected from the group of metals from groups 3-16, and the lanthanide series. More preferably, the metals are transition metals, mixtures thereof, and alloys thereof and their respective oxides. Most preferably, the metal or metals are selected from the group consisting of nickel, iron, manganese, cobalt, tin, and silver, or combinations, alloys, and oxides thereof. The nanoparticles may be the same as, substantially the same, or entirely different materials from those chosen for the electrode. Additionally, the nanoparticles may comprise a metal core and an oxide shell having a thickness in the range from 5 to 100% of the total particle composition, wherein the metal core may be an alloy.

The foregoing description is that of preferred embodiments having certain features, aspects, and advantages in accordance with the present inventions. Various changes and modifications also may be made to the above-described embodiments without departing from the spirit and scope of the inventions.

### EXAMPLE 1

### EFFECT OF NANOPARTICLE ADDITION TO UPPER (CATHODE) CHAMBER

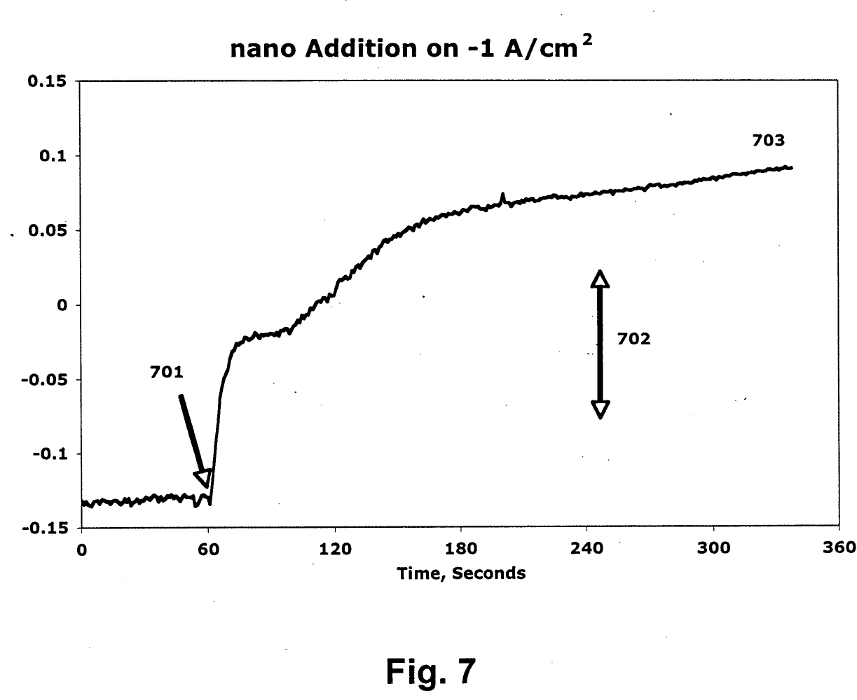

FIG. 7 illustrates the effect of injecting nano-catalyst into the upper chamber of the water electrolysis device. The electrolyzer is allowed to reach a steady-state voltage under 1 A/cm², which is evident after about 60 seconds. At time 701, nickel nanoparticles were added to the upper chamber of the electrolyzer. An efficiency increase of 10% was observed after addition of nickel nanoparticles 502. After about 15 minutes, steady state efficiency improvement was about 20%.

### EXAMPLE 2

### COMPARISON OF FIVE DIFFERENT CATHODE ELECTRODES

FIG. 8 compares the performance of several different cathode electrodes for a water electrolysis device. An improvement over the base electrode 801 with no catalytic powders added was observed when micron particles were added 802 on a 1 Amp/cm² load. This combination, however, agglomerated after less than an hour of running with significant degradation. The addition of nano-catalyst 803 increased the performance by nearly 4 times compared to the unanalyzed electrode 801. For reference, a 10% improvement line 804 is included in the FIG. 5.

### EXAMPLE 3

### HIGH RATE CAPABILITY OF ELECTROLYSIS DEVICE

FIG. 9 illustrates the improved rate capability of the electrolysis device described in the preferred embodiments relative to a more traditional system. This figure shows the voltage and current relationship of several electrode designs. Sets 901-904 are of a design compressed powders. Sets 905-906 show the preferred embodiment. Specifically, data sets 901/901′ show a carbon electrode, 902/902′ show a smooth nickel electrode, 903/903′ show a compressed micron sized nickel electrode, 904/904′ show a micron nickel with nano sized powders added then compressed, and 905/905′ show the preferred embodiment with no added catalyst and 906/906′ show the most preferred embodiment with nano-catalyst added. A voltage difference of 2 volts is about 75% efficiency. The last set of dots, 907, is a cell potential of 1,584 volts and represents over 90% efficiency when calculating the energy in the hydrogen divided by the energy it takes to electrolyze the water to make that hydrogen. The best traditional electrolysis system operates at less than 75% efficiency when run higher than 0.5 A/cm².

### EXAMPLE 4

### EFFECT OF FLUIDIZED BED

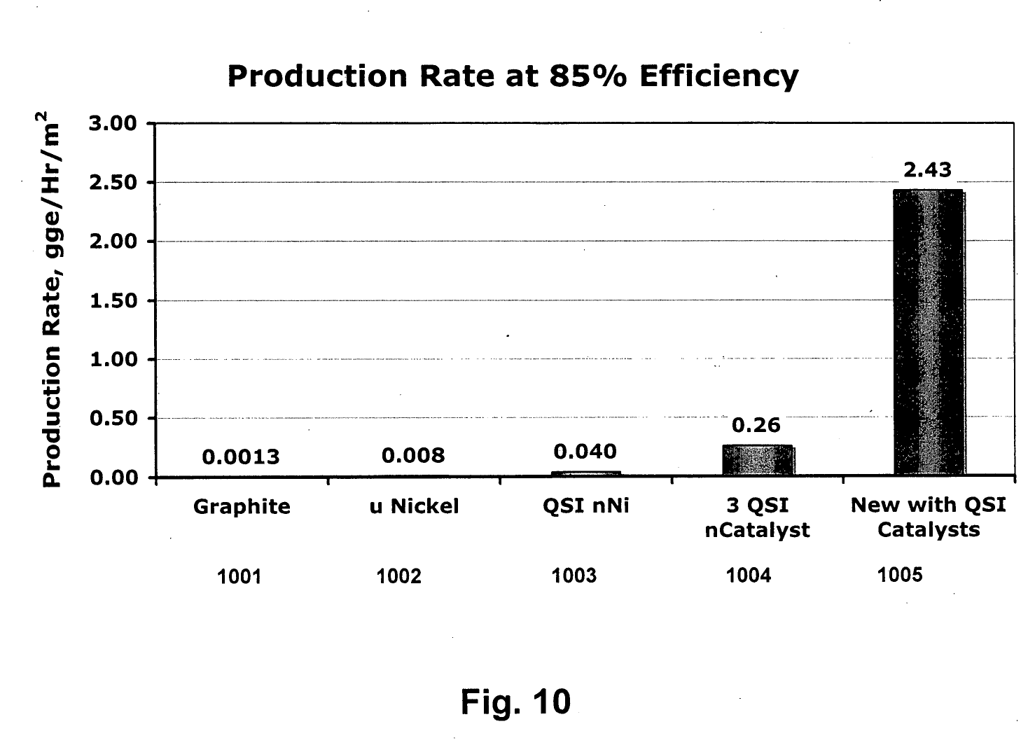

FIG. 10 shows the performance of five experiments with the most preferred embodiment to the right. Performance is expressed as the amount of hydrogen (as gge or gallon of gas equivalents) per hour per square meter of electrode surface. The set of comparisons is a graphite electrode 1001, a micron nickel catalyzed electrode 1002, a nano nickel catalyzed electrode 1003, an electrode catalyze using three different nano-sized catalysts 1004 and the fluidized bed electrolyzer 1005. Another way to compare these would be the amount of time it would take for a one square meter electrode to produce one gge. Table 1 below summarizes that data. The graphite produces hydrogen at 85% efficiency very slowly, requiring 32 days to make one gge while the fluidized bed takes just 25 minutes.

TABLE 1
Comparison of electrode rates from several different electrode designs.

| Design | Hr/gge/m\hat{ }2 |
|---|---|
| Graphite (1001) | 769 |
| u Nickel (1002) | 125 |
| QSI nNi (1003) | 25.0 |
| 3 QSI nCatalysts (1004) | 3.85 |
| New with QSI Catalysts (1005) | 0.412 |

What is claimed is:

1. A device suitable for use in an electrochemical and/or catalytic application, the device comprising a first component and a second component, the first component comprising a metal having substantial void volume and where said first component is at least partially exposed to a reaction medium during use, the second component comprising a plurality of reactive metal nanoparticles suspended in the reaction medium and substantially diffused through the first component when the device is in use.

2. The device of claim 1, wherein at least a substantial portion of the plurality of reactive metal particles comprises particles have an effective diameter of less than about 100 nm.

3. The device of claim 1, wherein at least a portion of the reactive metal particles comprise nanoparticles having an oxide shell.

4. The device of claim 1, wherein the plurality of reactive metal particles comprise one or more of the metals from groups 3-16, lanthanides, combinations thereof, and alloys thereof.

5. The device of claim 1, wherein the first component is a sintered porous metal plate.

6. The device of claim 1, wherein the first component is a reticulate metal plate.

7. The device of claim 1, wherein the first component comprises one or more of the metals from groups 3-16, lanthanides, combinations thereof, and alloys thereof.

8. The device of claim 1, wherein the device comprises an electrolysis cell whereby reaction products are produced when energy is applied.

9. The device of claim 8, wherein the device is configured to generate hydrogen from water.

10. The device of claim 1, wherein the device comprises an electrical energy generating device whereby energy may be provided in a controlled fashion.

11. An electrochemical system, comprising a first chamber and a second chamber, the first chamber being positioned at least partially above the second chamber when the system is oriented such that it can be used in at least one useful purpose, the first chamber comprising an electrode and electrolyte such that circulated electrolyte may flow generally parallel to an electrode via inlet and outlet ports when in use; the second chamber comprising an electrode and electrolyte such that, when in use, reactants may flux in a substantially perpendicular fashion from the lower face of the second chamber electrode, and gasses generated from reaction may leave the upper face of the electrode via gravitational force; the system further comprising a separator membrane disposed between the first and second chambers.

12. The system of claim 11, further comprising electrical contacts on the first and second electrodes to permit the flow of electricity therebetween.

13. The system of claim 11, further comprising a pump to circulate at least a portion of the electrolyte in the lower chamber.

14. The system of claim 11, wherein the system is configured and adapted to permit useful operation while being oriented such that the first chamber is positioned at least partially horizontally displaced from the second chamber.

15. The system of claim 11, wherein the electrolyte in the first chamber is generally confined to that space.

16. The system of claim 11, further comprising a plurality of reactive metal particles in the upper chamber suitably sized to permit particle diffusion into voids within one or both of the electrodes.

17. The system of claim 16, wherein at least a substantial portion of the reactive metal particles have an effective diameter of less than one micrometer.

18. The system of claim 17, wherein the nanoparticles have a diameter of less than about 100 nm.

19. The system of claim 16, wherein the plurality of reactive metal particles comprises a metal selected from the group consisting of metals from groups 3-16, lanthanides, combinations thereof, and alloys thereof.

20. The system of claim 11, wherein the separator membrane comprises an ionically conductive material.

21. The system of claim 20, wherein the separator membrane comprises multiple layers of ionically conductive material to increase mechanical chemical, and electrochemical durability.

22. The system of claim 11, wherein the electrolyte flow channel of the second chamber contains a deflector to aid in transport to the separator surface.

23. The system of claim 11, wherein the first chamber electrode is configured to generate hydrogen from water and the second chamber electrode is configured to generate oxygen from water.

24. An electrochemical system, comprising: a first chamber and a second chamber, the first chamber being disposed within the second chamber when the system is oriented such that it can be used in at least one useful purpose, the first chamber comprising an electrode, electrolyte, and metal catalyst particles arranged such that, when in operation, a fluidized bed may be established, and gaseous products may be removed from the upper portion of the first chamber; the second outer chamber comprising an electrode, electrolyte, and metal catalyst particles arranged such that, when in operation, a fluidized bed may be established, and gaseous products are removed from the upper portion of the second chamber.

25. The system of claim 24, further comprising a separator membrane disposed between the first and second chambers.

26. The system of claim 24, further comprising electrical contacts on the first and second electrodes to permit the flow of electricity therebetween.

27. The system of claim 24, wherein the electrolyte in the first chamber is generally confined to that space.

28. The system of claim 24, wherein the electrolyte in the second chamber is generally confined to that space.

29. The system of claim 24, wherein at least a substantial portion of the reactive metal particles have an effective diameter of less than one micrometer.

30. The system of claim 24, wherein the nanoparticles have a diameter of less than about 100 nm.

31. The system of claim 24, wherein the plurality of reactive metal particles comprises a metal selected from the group consisting of metals from groups 3-16, lanthanides, combinations thereof, and alloys thereof.

32. The system of claim 24, wherein the separator membrane comprises an ionically conductive material.

33. The system of claim 32, wherein the separator membrane comprises multiple layers of ionically conductive material to increase mechanical, chemical, and electrochemical durability.

34. The system of claim 24, wherein the first chamber electrode is configured to generate hydrogen from water and the second chamber electrode is configured to generate oxygen from water.

35. The system of claim 24, wherein a multiple of first inner chambers are placed within a single outer chamber, and where each inner chamber is electrically connected in a circuit with the outer chamber.

36. The system of claim 35, wherein the first chamber electrode is configured to generate hydrogen from water and the second chamber electrode is configured to generate oxygen from water.
